(19) United States
(12) Patent Application Publication
(10) Pub. No.: US 2008/0290711 A1
(43) Pub. Date: Nov. 27, 2008

(54) TOILETING CHAIR

(75) Inventors: Geoffrey Roy Fernie, Etobicoke (CA); Gerald Thomas Griggs, Scarborough (CA); Adam Mathew Sobchak, Toronto (CA)

Correspondence Address: BERESKIN AND PARR, 40 KING STREET WEST, BOX 401, TORONTO, ON, M5H 3Y2, CA

(73) Assignee: TORONTO REHABILITATION INSTITUTE, Toronto (CA)

(21) Appl. No.: 11/752,330

(22) Filed: May 23, 2007

(51) Int. Cl. B60N 2/02; A61G 9/00; F03G 7/00; G02B 5/08; B60M 1/14

(52) U.S. Cl. 297/338; 280/250.1; 359/838; 4/450; 60/721

(57) ABSTRACT

A toileting chair has a flexible seat support and a removable seat. The removable seat is positioned on a seat support platform. At least one of the seat support platform and the flexible seat support is vertically movable with respect to the others so as to permit the insertion and removal of the seat. The flexible seat support is independent of the drive means so as to provide a comfortable suspended support on which a person may be seated during the reconfiguration of the chair.

### FIELD OF THE INVENTION

This invention relates to a chair in which a person may be seated while toileting, and, in a preferred embodiment, this invention relates to a toileting wheelchair.

### BACKGROUND OF THE INVENTION

People who are disabled or infirm may need to toilet while seated in a chair. For example, a person seated in a chair may require assistance to be seated on a toilet, which assistance may not be available when they need to toilet, or they may not be easily be transferable to a toilet. Further, many wheelchair users may require toileting more frequently due to problems with their bladders. In addition, persons who are incontinent typically require an incontinent pad, and the pad must be changed from time to time. If the person is handicapped or infirm, then the person will require assistance to have the incontinent pad changed.

In view of these issues, different designs for wheelchairs have been proposed in the past. For example, Canadian Patent Application No. 2,097,644 discloses a body lifting apparatus for a wheelchair. The wheelchair has a seat. A body support is provided on a frame. A motor is provided which moves one of the body support and the seat relative to the other so that an open area is established between the body support and the seat. Accordingly, a bedpan may be inserted on the seat for use by a person when toileting while seated in the body support. The body support comprises a web of material with a toileting opening. Accordingly, when a person is toileting, they are positioned above the seat of the wheelchair on a flexible web. A disadvantage of this design is it provides an uncomfortable toileting position for a person.

U.S. Pat. No. 5,039,165 discloses a wheelchair toileting module. The wheelchair has two spaced apart straps that extend between the front and the rear of the seat of the wheelchair and are positioned on top of the seat. The straps are tightened to lift a person above the seat by moving a support bar outwardly, such that the bar would be positioned underneath the thighs of the person seated in the chair. Once the straps are tightened, a cushion may be removed and a bedpan may be inserted to permit toileting. A disadvantage of this design is that the positioning of the bar under the thighs of the user and the use of the straps provides an uncomfortable position for toileting.

### SUMMARY OF THE INVENTION

In accordance with the instant invention, a toileting chair, preferable a toileting wheelchair is provided which provides a solid surface upon which a person may be seated while toileting as well as providing a solid surface upon which a person may be seated during regular, non-toileting, use of the chair. Accordingly, except during the reconfiguration of the chair, the chair provides a solid surface upon which a person is seated thereby decreasing any discomfort or anxiety a person may feel from being suspended by a sling or the like.

In the non-toileting, regular configuration of the chair, a person is seated on a solid surface, which may be a rigid panel and, preferably, is resilient. One or more gel inserts, foam, or the like may be utilized to provide a resilient or yielding surface upon which a person may be seated. It is to be appreciated that a toileting chair may be occupied by a user for an extended period of time. Accordingly, it is preferred to provide a comfortable, cushioned surface upon which a person may be seated so as to reduce and, preferably, minimize discomfort.

In the toileting configuration, the person is seated on a firm support. For example, the firm support may comprise a generally rigid panel that has an opening sized to receive a bedpan or that has a bedpan incorporated therein as a one-piece assembly. Accordingly, when the person is seated on the chair in the toileting configuration, the person is supported by a flat surface and the bedpan is positioned beneath an opening. Alternately, the surface surrounding the opening for the bedpan, or the top surface of the bedpan itself, may be shaped like a toilet seat. It will be appreciated that, as with toilet seats, the support member may have padding to provide additional comfort. One advantage of this design is that, when toileting, a person is not suspended in the air but is seated on a rigid surface. Accordingly, this reduces any anxiety that may be experienced by a person while trying to toilet while suspended in a sling. In addition, the person using the toileting chair may have diminished mental faculties. Sitting on a solid surface for toileting may assist that person to toilet by creating an environment similar to being seated on a toilet.

It will be appreciated that, in a further embodiment, the bedpan may have a top surface that is sized to provide a comfortable seat for a person while toileting. According to such an embodiment, the bedpan may be securely mounted in a frame, rigid surface or the like provided that the bedpan, itself or with other members, is removable for cleaning and provides a stable platform upon which a person may be seated during toileting.

In accordance with this invention, the person may remain seated in the toileting chair while the chair is reconfigured. Accordingly, the chair is provided with a flexible support seat that has a toileting opening. The person remains seated on this flexible support seat at all times. Positioned below the flexible support seat is a seat member that is used in the normal, non-toileting configuration of the chair (e.g. a removable cushion). Beneath the removable cushion is a seat support platform, which removably receives a bedpan, a bedpan and a bedpan mount, or the like. When the person requires toileting, the position of the flexible support seat is moved relative to the removable cushion. This permits the removable cushion to be removed. The bedpan may then be inserted. The relative position of the seat support platform and the flexible support seat may then be adjusted so that the person is seated on a rigid member holding the bedpan. When the person has finished toileting, the process may be reversed and the chair reconfigured to its normal mode such that the person is now seated on the removable cushion.

It will be appreciated that the seat support platform may comprise an open area, which removably receives a panel including a waste container (e.g. bedpan). Alternately, the seat support platform may comprise a generally horizontal planer member having a bedpan opening that removably receives the bedpan, or to which a bedpan is mounted therebelow. Any construction that provides a stable surface for toileting and permits the bedpan or like container to be removed may be used.

During normal configuration, the chair provides firm support to a person seated therein such that the person does not fall into the bedpan opening. Accordingly, a rigid member is provided to bridge the bedpan opening. The rigid member may be a flat panel, which is provided as part of the removable cushion (e.g. a hard backing board for the removable cushion). Alternately, if the bedpan opening comprises a bedpan shaped opening in a horizontal planer member, a closure member may be provided which is movable between an open position, in which the bedpan opening is provided, in a closed position in which the rigid member extends across the bedpan opening to provide a rigid support surface. For example, the closure member may comprise a panel slidably mounted beneath the seat support platform.

In accordance with one embodiment of this invention, there is provided a toileting chair comprising:
(a) a frame including a seat support platform, the seat support platform having a bedpan opening and removably receiving a bedpan aligned with the bedpan opening;
(b) a flexible support seat having a front end, a rear end and spaced apart sides and mounted on the frame above the seat support platform and having a region contacted by a person when seated in the chair, the region being continuous except for a toileting opening provided for toileting and positioned above the bedpan opening;
(c) a removable seat positionable on the seat support platform and having an upper surface and a lower surface;
(e) a member to adjust the position of at least one of the seat support platform and the flexible seat support between a first position in which the flexible support seat is positioned on the removable seat and a second position in which the flexible support seat is spaced from the removable seat whereby the removable seat is freely slidably removable from the seat support platform; and,
(f) an access area positioned and sized to permit sequential insertion and removal of the removable seat and a bedpan.

In one embodiment the toileting chair further comprises spaced apart side flexible seat support mounts.

In another embodiment, the flexible seat support extends generally continuously between the flexible seat support mounts and the front and rear ends are freely moveable with respect to the seat support platform.

In another embodiment, the flexible seat support is suspended at its sides.

In another embodiment, the member is drivingly connected to the seat support platform.

In another embodiment, the member comprises a motor.

In another embodiment, the member further adjusts the position of at least one of the seat support platform and the flexible seat support between the second position and a third position in which the flexible support seat is positioned on the seat support platform.

In another embodiment, the seat support platform is adapted to removably receive a bedpan.

In another embodiment, the bedpan has a top and, when installed, the top of the bedpan is generally flush a support area surrounding the top of the bedpan.

In another embodiment, the toileting chair further comprises a mirror surface provided beneath the flexible seat support and positioned to permit a person adjacent the chair to view the toileting opening in the region when a bedpan is not inserted. Preferably, the mirror surface is provided beneath the seat support platform.

In another embodiment, the toileting chair further comprises wheels affixed to the frame whereby the chair is a wheelchair.

In another embodiment, the toileting chair further comprises bridging the bedpan opening and moveable to expose the bedpan opening during toileting is provided. The rigid member may be positionable over the bedpan opening and beneath the upper surface of the removable seat. For example, the rigid member may be provided as part of the removable seat.

In another embodiment, the bedpan opening is closeable.

In accordance with one embodiment of this invention, there is also provided a toileting chair comprising:
(a) a frame including a seat support platform, the seat support platform having a bedpan opening and removably receiving a bedpan aligned with the bedpan opening;
(b) a flexible support seat having a front end, a rear end and spaced apart sides and mounted on the frame above the seat support platform and having a region contacted by a person when seated in the chair, the region having a toileting opening provided for toileting and positioned above the bedpan opening;
(c) a removable seat positionable on the seat support platform and having an upper surface and a lower surface;
(d) a rigid member bridging the bedpan opening and moveable to expose the bedpan opening during toileting;
(e) a member to adjust the position of at least one of the seat support platform and the flexible seat support between a first position in which the flexible support seat is positioned on the removable seat and a second position in which the flexible support seat is spaced from the removable seat whereby the removable seat is freely slidably removable from the seat support platform, the flexible support seat is independent of the member; and,
(f) an access area positioned and sized to permit sequential insertion and removal of the removable seat and a bedpan.

In accordance with one embodiment of this invention, there is also provided a method of permitting a person to toilet while seated in a chair, the chair having a flexible seat web moveably mounted with respect to a seat support platform, the seat support platform having a bedpan opening for removably receiving a bedpan aligned with the bedpan opening, the flexible seat web having a portion for supporting a person when seated in the chair and a toileting opening positioned over the bedpan opening, the method comprising:
(a) adjusting the position of the seat support platform relative to the flexible support web without tensioning the flexible seat web other than due to the weight of a person seated on the web whereby the person is seated on the flexible seat web and all of the flexible seat web is positioned above a removable seat;
(b) removing the removable seat; and,
(c) associating a bedpan with the seat support platform and adjusting the position of the seat support platform relative to the flexible support web to provide a stable surface for the person when toileting.

In one embodiment, the method further comprises mounting the bedpan beneath bedpan opening in the seat support platform and step (c) comprises adjusting the position of the seat support platform relative to the flexible support web such that the person is supported by the seat support platform when toileting.

In another embodiment, the seat support platform is moveably mounted and step (a) comprises lowering the seat support platform and step (c) comprises raising the seat support platform.

In another embodiment, the method further comprises using a mirror surface provided beneath the seat support platform and positioned to permit a person adjacent the chair to view the toileting opening when the chair is in the position at the end of step (a) and the bedpan has been removed.

In another embodiment, the chair further comprises a rigid member positionable over the bedpan opening and beneath the upper surface of the removable seat and the method further comprises removing the rigid member with the removable seat prior to the person toileting.

In another embodiment, the chair further comprises a rigid member that extends over the bedpan opening and the method further comprises moving the rigid member to expose the bedpan opening prior to a person using the bedpan for toileting.

In another embodiment, the rigid member comprises part of the removable seat whereby step (d) comprises simultaneously removing the removable seat and the rigid member.

In another embodiment, the rigid member comprises a moveable closure member affixed to the chair and the method further moving the closure member to an open position to expose the bedpan opening prior to a person using the bedpan for toileting.

### BRIEF DESCRIPTION OF THE DRAWINGS

These and other advantages of the instant invention will be more fully and completely understood in accordance with the following description of the preferred embodiment of the invention in which:

FIG. 1 is a perspective view from the front of a toileting wheelchair according to the instant invention;

FIG. 2 is a perspective view of the rear of the toileting wheelchair of FIG. 1;

FIG. 3 is an exploded view of a portion of the rear of the toileting wheelchair of FIG. 1 showing the wheelchair being reconfigured;

FIG. 4 is a partially cut away view of the toileting wheelchair of FIG. 1 with the removable cushion and bedpan removed;

FIG. 5 is a schematic view from the rear of a toileting wheelchair in the normal configuration;

FIG. 6 is a schematic view of the wheelchair of FIG. 5 showing the wheelchair being reconfigured to the toileting mode;

FIG. 7 is a schematic view of the wheelchair of FIG. 5 showing the wheelchair in the toileting configuration; and,

FIG. 8 is a schematic view of the wheelchair of FIG. 5 showing the wheelchair being configured to the normal configuration.

### DETAILED DESCRIPTION OF THE INVENTION

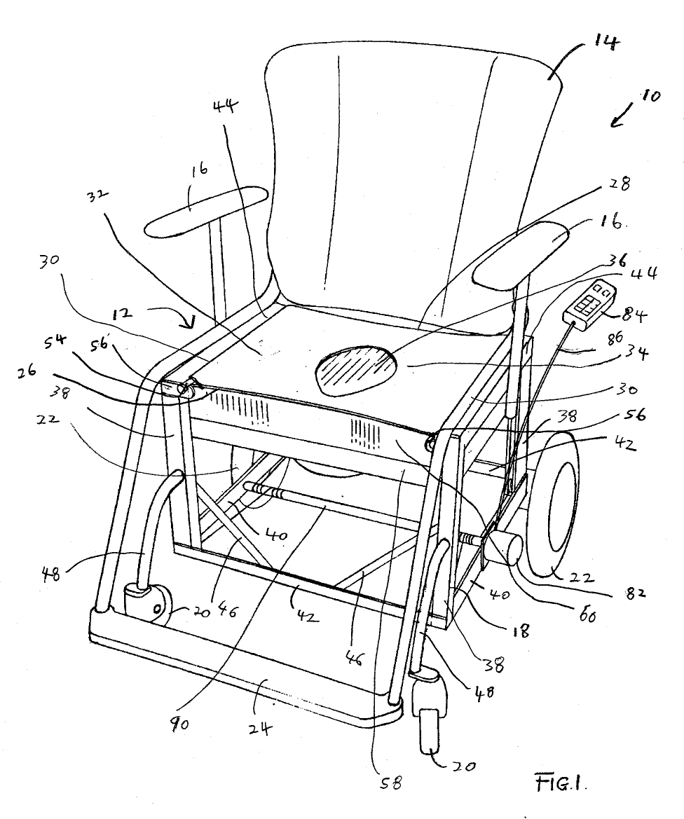

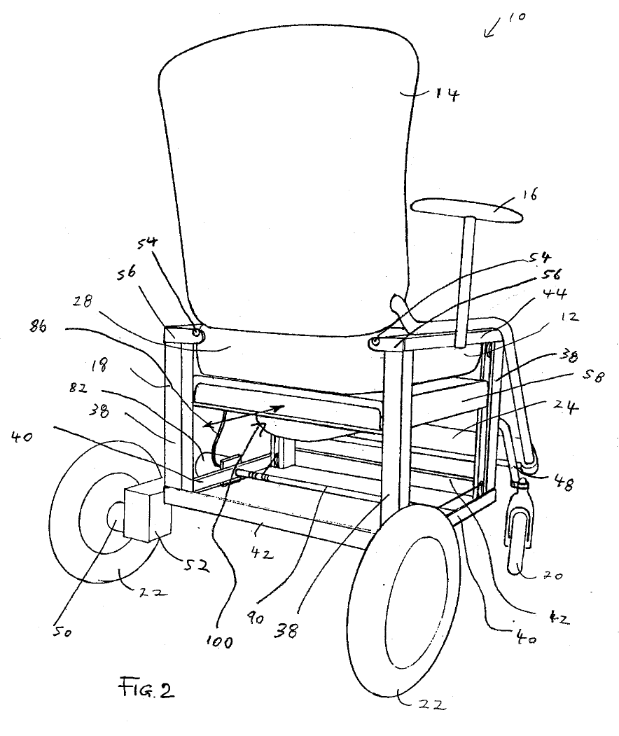

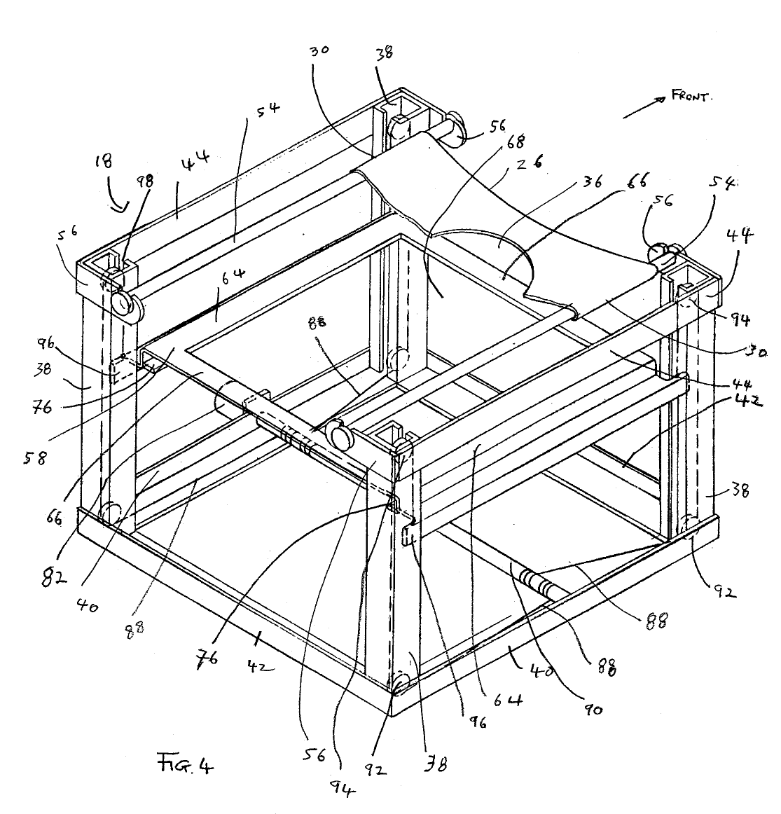

It will be appreciated by those skilled in the art that the chair may be for any particular seating use. For example, the seat may be a fixed, non-movable seat. Further, the seat may be in the form of an armchair. Preferably, as exemplified in FIGS. 1 and 2, the chair comprises a wheelchair. However, it will be appreciated by those skilled in the art that the frame and mechanism exemplified in FIGS. 5-8 may be utilized in any seating apparatus.

As shown in FIGS. 1 and 2, wheelchair 10 has a seat 12, backrest 14, optional arms 16, frame 18, front wheels 20 and rear wheels 22. Wheelchair 10 may be of any configuration known in the art. Accordingly, any style of wheels, arms, backrest and other standard or optional features, such as a footrest 24, may be provided. It will also be appreciated that wheelchair 10 may be motorized so that it is self-propelled.

In accordance with the instant invention, a flexible seat support 32 is provided. Flexible seat support 32 has a front end 26, a rear end 28 and spaced apart sides 30. Flexible seat support 32 has a central region 34, which is contacted by a person when seated in a chair. Region 34 is provided with toileting opening 36. At least region 34 comprises a generally continuously member, except for toileting opening 36. Accordingly, when a person is seated on flexible seat support 32, they experience the feeling of sitting on a continuous extended material and not merely straps. Preferably, all of flexible seat support 32 comprises a generally continuous member except for toileting opening 36.

Flexible support seat may be made from any woven or non-woven material and, preferably, is made from a washable material. Flexible support seat 32 may be an open mesh material so as to provide a breathable web.

Frame 18 may be of any general construction known in the chair arts and, in particular in the wheelchair arts, provided it includes an open area for receiving a bedpan. For example, a shown in FIGS. 1 and 2, frame 18 includes four generally vertically extending members 38 which are positioned at the four corners of the wheelchair. At the lower end of vertically extending members 38, longitudinally extending members 40 are preferably provided. Members 40 extend between the front end of frame 18 and rear end of frame 18. In addition, at the lower end of vertical members 38, transversely extending members 42 are also preferably provided at the front and rear of the chair. Accordingly, members 40 and 42 define a generally continuous perimeter of the base of frame 18. Upper longitudinally extending members 44 are provided at the upper end of vertical member 38 and extend between the front and rear of the wheelchair so as to stabilize the upper ends of vertical members 38. Upper transversely extending members may be provided (not shown). Essentially, the longitudinally extending members and the transversely extending members dimensionally stabilize vertical members 38. As shown in particular in FIG. 4, the transversely extending and longitudinally extending members are preferably L-shaped so as to provide additional rigidity to frame 18. Similarly, vertical members 38 may be generally C-shaped so as to provide structural rigidity. It will be appreciated that many different structures may be utilized for frame 18. For example, a channel may be provided by any means known in the mechanical arts. Alternately, a channel need not be provided as the movement of the seat support platform may have any guide means known in the mechanical arts. In addition, it will be appreciated that optional braces 46 may be provided and that the width of the chair may be adjustable.

Wheels 20, 22 may be directly mounted to frame 18 or to support legs that extend from frame 18. For example, a shown in FIG. 1, front wheels 20 are provided at the lower end of front leg supports 48. As shown therein, front wheels 20 preferably swivel about a generally vertical axle and may be casters. The upper end of each front leg support 48 is preferably affixed to a vertical member of frame 18. As exemplified in FIG. 2, each rear wheels 22 may be provided with a horizontal axle 50, which is mounted to bearings in a bearing housing 52 that is attached to frame 18. However, any other construction known in the wheelchair arts may be utilized.

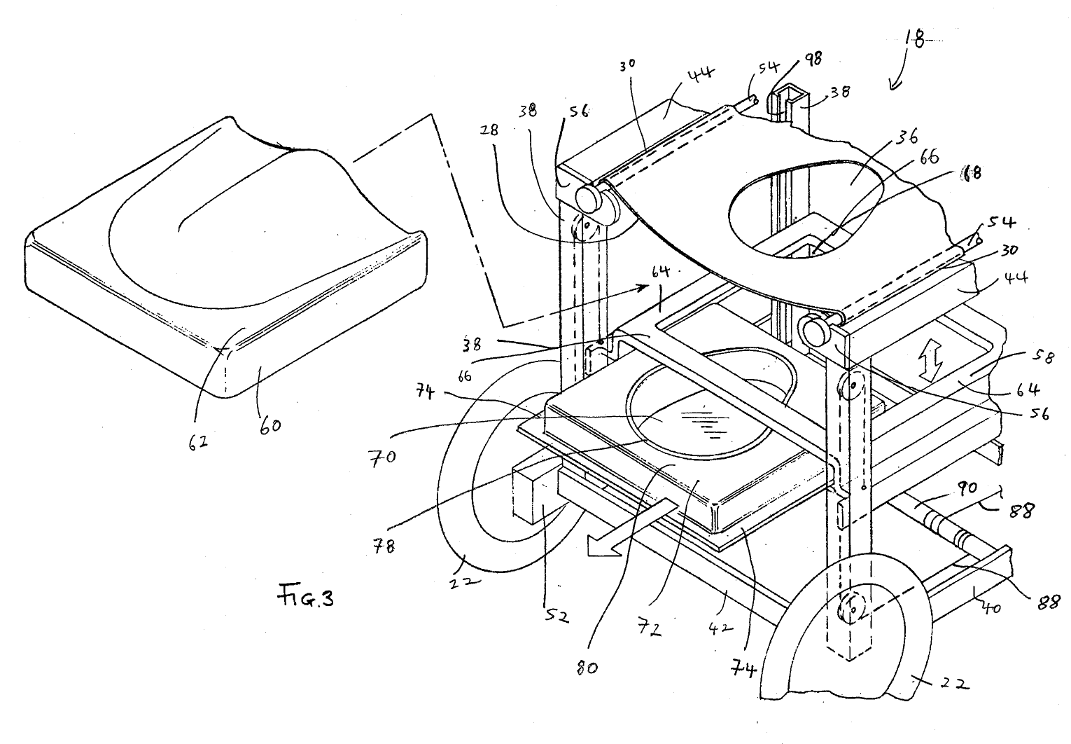

Longitudinally extending sides 30 of flexible seat support 32 are preferably mounted adjacent the sides of frame 18, and may be removably mounted thereto. For example, as exemplified in FIG. 3, each side 30 is affixed to a flexible seat support mount 54. Sides 30 may be affixed in a grove provided in flexible seat support mounts 54. Alternately, as exemplified in FIGS. 5-8, each lateral end of flexible seat support 32 may be looped back and secured to flexible seat support 32 so as to define a longitudinally extending channel through which flexible seat support mount 54 may be passed. Any other securing means known in the art, such as the use of adhesive, clamps, screws or the like, may be utilized. Alternately, seat support 32 may be removably mounted to flexible seat support mount 54.

Flexible seat support mounts 54 may be secured to frame 18, and preferably removably secured thereto, by any means known in the art. For example, as shown in FIG. 3, flexible seat support mounts 54 are received in flanges 56, which preferably have a recess for receiving flexible seat support mounts 54. It will be appreciated that flexible seat support mounts 54 are preferably removably secured to frame 18 by any means known in the art so as to permit flexible seat support 54 to be removed and replaced if required or at least removed for cleaning. For example, flanges 56 may have a closure member which, when locked in position, secures flexible seat support mount 54 in position and, when in the open position, permits flexible seat support mount 54 to be lifted vertically upwardly away from frame 18. Alternately, set screws or other clamping means may be used. It will be appreciated that a flange 56 is preferably provided at each vertical member 38. Any other means known in the art may be used to secure, and preferably removably secure, flexible seat support mount 54 to frame 18. Further, flanges 56 may also incorporate a tensioning member operatively connected to flexible seat support 32 (not shown) for applying tension to the flexible seat support and thereby providing a more horizontal profile for the flexible seat support. For example, flexible seat support may be rolled onto flexible seat support mounts 54, such as by a ratcheting system. Alternately, or in addition, flexible seat support mounts 54 may be moveable outwardly, such as by means of a motor, to tension the flexible seat support. The increased tension, that results in the flexible seat support being more taught and therefore straighter, with less sagging, may be used while a person is suspended while the wheelchair is reconfigured between the normal use mode and the toileting chair mode.

A seat support platform 58 is provided at an upper end of frame 18. In the normal, non-toileting configuration, removable cushion 60 is provided between seat support platform 58 and flexible seat support 32. Removable cushion may be of any particular configuration. As shown in FIG. 3, removable cushion may be saddle shaped so as to provide a more comfortable surface on which a person may be seated for an extended period of time. However, it will be appreciated that upper surface 62 may be of any particular configuration, for example, it may be flat. Preferably, removable cushion is a resilient member. Accordingly, it may be constructed with foam, gel, air bladders or any other resilient material known in the seating or wheelchair arts.

Removable cushion 60 is configured to be removably mounted to seat support platform 58, such as being placed on top thereof or slidably received in a groove or removeably fixed in place. As shown in FIGS. 3 and 4, seat support platform 58 has longitudinal sides 64 and transverse sides 66, which define a perimeter around bedpan opening 68. In this embodiment, bedpan opening 68 essentially comprises most of the area defined by sides 64, 66. It will be appreciated that seat support platform may be of any configuration provided it has an opening sufficiently large to permit the use of a bedpan. Therefore, seat support platform 58 may have a top surface that extends inwardly from sides 64, 66.

As exemplified in the embodiment of FIGS. 3 and 4, removable cushion 60 is sized so as to reset on top of longitudinal sides 64 and transverse sides 66. In order to ensure removable cushion 60 provides a stable platform on which a person may be seated, a rigid member is provided to bridge bedpan opening 68. As exemplified herein, the rigid member is built into removable cushion 60 and may comprise a metal or wood panel, which may be the lower surface of removable cushion 60 (not shown). Accordingly, when placed on seat support platform 58, a person may be comfortably seated on flexible seat support 32, which is adjacent to upper surface 62 of cushion 60, which is positioned on seat support platform 58. It will be appreciated that the rigid member may be a separate element that is removably received on seat support platform 58.

In an alternate embodiment, it will be appreciated that bedpan opening 68 may be substantially smaller and, may be the size or shape of a standard bedpan. Accordingly, seat support platform would have a generally continuous upper surface but for the standard size bedpan opening 68. In such a case, the rigid member would be the continuous upper surface and could optionally include a closure member, which covers the small bedpan opening 68 when cushion 60 is positioned on seat support platform 58. For example, in such a case, the closure member may be a panel pivotally mounted to seat support platform 58 or slidably mounted thereto, and movable between a closed position, in which it is positioned to extend across bedpan opening 68 and provide a solid support surface, and an open position in which bedpan opening 68 is open to permit toileting. In such a case, cushion 60 need not have a rigid member provided as part thereof.

If seat support platform 58 provides a large opening, then as exemplified in FIG. 3, bedpan 70 may be provided with bedpan support 72. Bedpan 70 may be formed as part of bedpan support 72, or may be removably mounted thereto. If bedpan support 72 is maintained in position when the chair is in the normal, non-toileting configuration, then bedpan support 72 may function as the rigid member.

Seat support platform 58 removably receives a bedpan which, when mounted on seat support platform 58, is aligned with bedpan opening 68. As exemplified in FIG. 3, bedpan 70 may be provided with bedpan support 72, which is provided with flanges 74 that are slidably received on flange support 76 that are provided on the lower surface of seat support platform 58. Accordingly, bedpan support 72, with bedpan 70 therein, is slidably receivable in seat support platform 58. When inserted, top 78 of bedpan 70 is essentially flush, e.g. in the same general plane as seat support platform 58. Accordingly, when chair 10 is in the toileting configuration, flexible seat support 32 is positioned on top of bedpan support 72 and upper surface 80 of bedpan support 72 provides a rigid surface upon which a person may be seated while toileting. It will be appreciated if seat support platform 58 is a generally continuous surface with a bedpan sized bedpan opening 68, that in the toileting configuration, a person will be supported by the seat support platform and a bedpan support 72 may not be required.

In order to move between the normal, non-toileting configuration and the toileting configuration, at least one of flexible seat support 32 and seat support platform 58 is movable and, optionally, both may be movable. In particular, chair 10 is designed so that an opening may be provided between seat support platform 58 and flexible seat support 32 so as to permit cushion 60 to be removed during the reconfiguration of chair 10. Any member known in the art may be utilized to vertically displace one or both of flexible seat support 32 and seat support platform 58. The member may be motorized or may be manually movable. Preferably, seat support platform 58 is vertically movable and flexible seat support 32 is stationary. An advantage of this latter design is that a person seated in chair 10 does not move during the reconfiguring procedure.

As exemplified in FIGS. 1 and 2, motor 82 is mounted on frame 18 and is preferably controlled by a controller 84, which is operatively connected to motor 82 via cable 86. It will be appreciated that motor 84 may be controlled by buttons provided on chair 10. Further, controller 84 may be wirelessly connected to motor 82, such as by infrared or Bluetooth™ technology.

Motor 82 may be utilized to one or more drive cables 88 to raise and lower seat support platform 58. In the exemplified embodiment, four cables are utilized. Each cable 88 has an end secured to one corner of seat support platform 58 and the other end is secured to rod 90. Accordingly, cable 88 extends longitudinally (i.e. either forwardly or rearwardly) to a lower pulley 92 and then upwardly around an upper pulley 94 prior to extending downwardly to seat support platform 58. Accordingly, when motor 82 is operated in one direction, rod 90 will rotate in a first direction unwinding cable 80 and permitting seat support platform 58 to be lowered, e.g., due to gravity. When motor 80 is operated in the reverse direction, rod 90 will rotate in the reverse direction drawing in cable 88 and thereby raising platform 58. In order to stabilize the movement of seat support platform 58, each corner of seat support platform 58 may have a flange 96 that travels in a grove 98 of vertical member 38.

In the normal and toileting configuration, a portion of wheelchair 10 is open so as to permit the insertion and removal of removable cushion 60 and the insertion and removal of bedpan 70 (which may be positioned in a bedpan support 72). Optionally, bedpan 70 and cushion 60 may be inserted and removed from different opening. Preferably, the same opening is utilized to insert and remove each of these items. The opening, referred to herein as access area 100, may comprise an open area at the rear of chair 10. In an alternate construction, it will be appreciated that cushion 60 and/or bedpan 72 may be inserted and removed from a side or the front of chair 10.

In an alternate construction, it will be appreciated that the vertical movement of seat platform 58 and/or flexible seat support 32 may be achieved by use of pneumatics, scissors arms, and the like.

The reconfiguration of chair 10 will be explained with reference to FIGS. 5-8. In the configuration of FIG. 5, chair 10 is in the normal, non-toileting configuration. This can be considered the first position of seat support platform 58. In this configuration, flexible support seat 32 is positioned adjacent upper surface 62 of cushion 60. Accordingly, when seated in chair 10, a person is supported by cushion 60. It will be appreciated that, in other embodiments, flexible support member 32 may take some of the weight of a person seated in chair 10. In addition, optionally, bedpan 70 need not be positioned in chair 10 at this time.

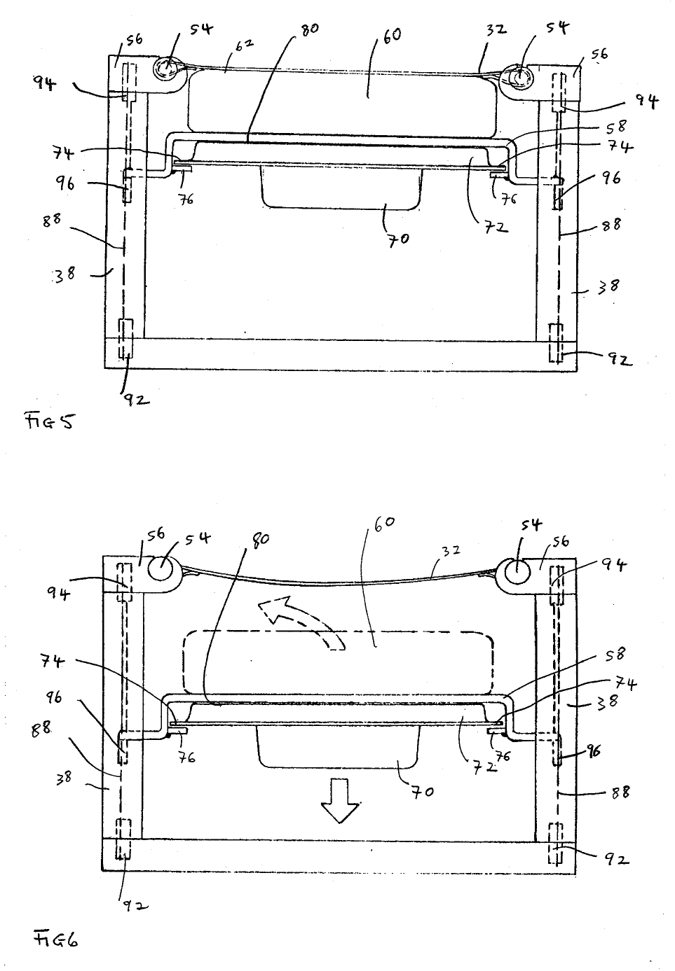

When a person seated in chair 10 needs to toilet, motor 82 is actuated so as to unroll cable 88 permitting seat support platform 58 to descend due to the force of gravity. The person seated in chair 10 is supported by flexible seat support 32, which is suspended from flexible seat support mounts 54. As shown in FIG. 6, the front and rear ends 26, 28 of flexible seat support 32 are freely movable with respect to seat support platform 58. Accordingly, no support member extends upwardly from seat support member 58 so as to provide a surface on which a person is seated. Therefore, the person is supported by a sling. Seat support platform 58 is lowered at least a sufficient amount so as to permit cushion 60 to be removed via access area 100. Concurrently or sequentially, bedpan 70 may be inserted (if it is not already in position). This represents a second position of seat support platform 58.

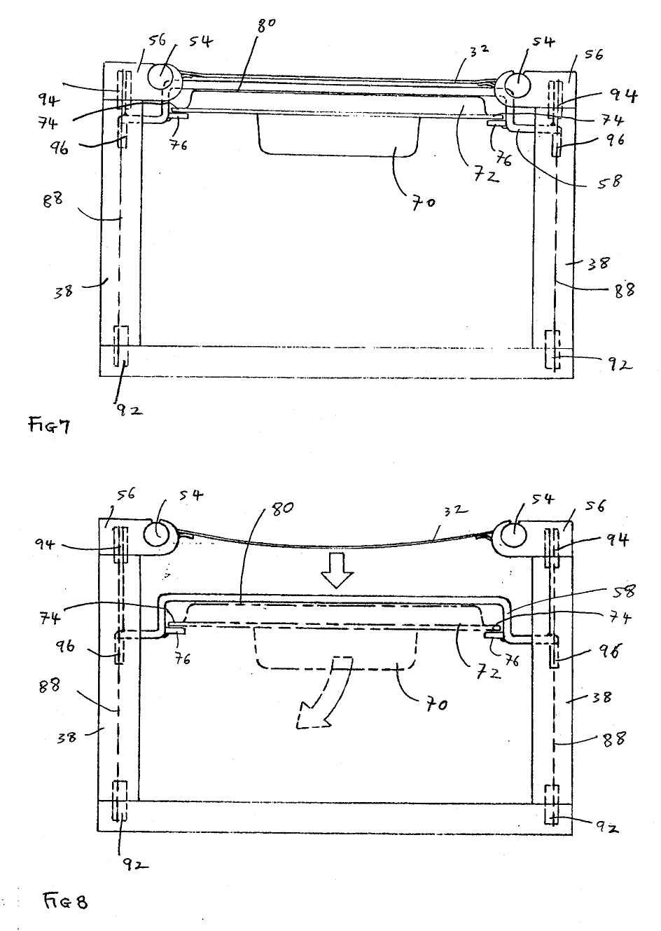

Once cushion 60 has been removed, seat support platform 58 is then raised to the position shown in FIG. 7. Accordingly, motor 82 is operated in the reverse direction until upper surface 80 of bedpan support 72 is positioned adjacent flexible seat support 32. In this position, upper surface 80 will support the weight of a person seated in chair 10. Accordingly, a solid support platform is provided for a person while toileting. Accordingly, FIG. 7 represents the toileting configuration of chair 10 and a third position of seat support platform 58. It will be appreciated that the top and bottom positions may be defined by auto end-stops that shut off power in the direction of movement when an end limit is reached, as is known in the art.

After a person has finished toileting, seat support platform 58 may be lowered (e.g. to the second position). Accordingly, bedpan 70 and bedpan support 72 may be removed. At this time, the person seated in the chair may be cleaned, if required and, or an incontinent pad may be inserted through toileting opening 36 to a position underneath the person. It will be appreciated that, in an alternate embodiment, only bedpan 70 need be removed. In addition, a separate rigid member may be provided to close bedpan opening 68.

Subsequently, cushion 60 may be reinserted and seat support platform 58 raised to the position shown in FIG. 5. Accordingly, the reconfiguration of the chair from a toileting configuration to a normal, non-toileting configuration is completed.

In an alternate embodiment, a mirror surface may be provided beneath flexible seat support 32 and positioned to permit a person (e.g. a nurse) positioned adjacent to chair 10, (e.g., standing, sitting or bending over) to view toileting opening 36 and determine whether a person requires cleaning. For example, the mirror surface may be provided as a lower surface that extends across the area defined by transverse members 42 and longitudinal members 40. In particular, if a mirror surface is provided, then it is preferred that seat support platform 58 is provided with a generally open area as exemplified such that a bedpan support 72 is required.

It will be appreciated by those skilled in the art that various modifications and additions may be made to chair 10 and all of these are with the scope of the following claims.

1. A toileting chair comprising:
(a) a frame including a seat support platform, the seat support platform having a bedpan opening and removably receiving a bedpan aligned with the bedpan opening;
(b) a flexible support seat having a front end, a rear end and spaced apart sides and mounted on the frame above the seat support platform and having a region contacted by a person when seated in the chair, the region being continuous except for a toileting opening provided for toileting and positioned above the bedpan opening;
(c) a removable seat positionable on the seat support platform and having an upper surface and a lower surface;
(d) a member to adjust the position of at least one of the seat support platform and the flexible seat support between a first position in which the flexible support seat is positioned on the removable seat and a second position in which the flexible support seat is spaced from the removable seat whereby the removable seat is freely slidably removable from the seat support platform; and,
(e) an access area positioned and sized to permit sequential insertion and removal of the removable seat and a bedpan.

2. The toileting chair of claim 1 further comprising spaced apart side flexible seat support mounts.

3. The toileting chair of claim 2 wherein the flexible seat support extends generally continuously between the flexible seat support mounts and the front and rear ends are freely moveable with respect to the seat support platform.

4. The toileting chair of claim 1 wherein the flexible seat support is suspended at its sides.

5. The toileting chair of claim 1 wherein the member is drivingly connected to the seat support platform.

6. The toileting chair of claim 1 wherein the member comprises a motor.

7. The toileting chair of claim 1 wherein the member further adjusts the position of at least one of the seat support platform and the flexible seat support between the second position and a third position in which the flexible support seat is positioned on the seat support platform.

8. The toileting chair of claim 1 wherein the seat support platform is adapted to removably receive a bedpan.

9. The toileting chair of claim 1 wherein the bedpan has a top and, when installed, the top of the bedpan is generally flush a support area surrounding the top of the bedpan.

10. The toileting chair of claim 1 further comprising a mirror surface provided beneath the flexible seat support and positioned to permit a person adjacent the chair to view the toileting opening in the region when a bedpan is not inserted.

11. The toileting chair of claim 10 wherein the mirror surface is provided beneath the seat support platform.

12. The toileting chair of claim 1 further comprising wheels affixed to the frame whereby the chair is a wheelchair.

13. The toileting chair of claim 1 further comprising a rigid member bridging the bedpan opening and moveable to expose the bedpan opening during toileting.

14. The toileting chair of claim 13 wherein the rigid member is provided as part of the removable seat.

15. The toileting chair of claim 1 wherein the bedpan opening is closeable.

16. The toileting chair of claim 1 further comprising a tensioning member operatively connected to flexible seat support.

17. A toileting chair comprising:
(a) a frame including a seat support platform, the seat support platform having a bedpan opening and removably receiving a bedpan aligned with the bedpan opening;
(b) a flexible support seat having a front end, a rear end and spaced apart sides and mounted on the frame above the seat support platform and having a region contacted by a person when seated in the chair, the region having a toileting opening provided for toileting and positioned above the bedpan opening;
(c) a removable seat positionable on the seat support platform and having an upper surface and a lower surface;
(d) a member to adjust the position of at least one of the seat support platform and the flexible seat support between a first position in which the flexible support seat is positioned on the removable seat and a second position in which the flexible support seat is spaced from the removable seat whereby the removable seat is freely slidably removable from the seat support platform, the flexible support seat is independent of the member; and,
(e) an access area positioned and sized to permit sequential insertion and removal of the removable seat and a bedpan.

18. The toileting chair of claim 17 further comprising spaced apart side flexible seat support mounts.

19. The toileting chair of claim 18 wherein the flexible seat support extends between the flexible seat support mount and the front and rear ends are freely moveable with respect to the seat support platform.

20. The toileting chair of claim 17 wherein the region is continuous except for a toileting opening

21. The toileting chair of claim 17 wherein the flexible seat support comprises a sling.

22. The toileting chair of claim 17 wherein the member is drivingly connected to the seat support platform.

23. The toileting chair of claim 17 wherein the member comprises a motor.

24. The toileting chair of claim 17 wherein the member further adjusts the position of at least one of the seat support platform and the flexible seat support between the second position and a third position in which the flexible support seat is positioned on the seat support platform.

25. The toileting chair of claim 17 wherein the seat support platform is adapted to removably receive a bedpan.

26. The toileting chair of claim 17 wherein the bedpan has a top and, when installed, the top of the bedpan is generally flush a support area surrounding the top of the bedpan.

27. The toileting chair of claim 17 further comprising a mirror surface provided beneath the flexible seat support and positioned to permit a person adjacent the chair to view the toileting opening in the region when a bedpan is not inserted.

28. The toileting chair of claim 27 wherein the mirror surface is provided beneath the seat support platform.

29. The toileting chair of claim 17 further comprising wheels affixed to the frame whereby the chair is a wheelchair.

30. The toileting chair of claim 17 further comprising a rigid member bridging the bedpan opening and moveable to expose the bedpan opening during toileting.

31. The toileting chair of claim 30 wherein the rigid member is provided on the lower surface of the removable seat.

32. A method of permitting a person to toilet while seated in a chair, the chair having a flexible seat web moveably mounted with respect to a seat support platform, the seat support platform having a bedpan opening for removably receiving a bedpan aligned with the bedpan opening, the flexible seat web having a portion for support a person when seated in the chair and a toileting opening positioned over the bedpan opening, the method comprising:
(a) adjusting the position of the seat support platform relative to the flexible support web without tensioning the flexible seat web other than due to the weight of a person seated on the web whereby the person is seated on the flexible seat web and all of the flexible seat web is positioned above a removable seat;
(b) removing the removable seat; and,
(c) associating a bedpan with the seat support platform and adjusting the position of the seat support platform relative to the flexible support web to provide a stable surface for the person when toileting.

33. The method of claim 32 further comprising mounting the bedpan beneath bedpan opening in the seat support platform and step (c) comprises adjusting the position of the seat support platform relative to the flexible support web such that the person is supported by the seat support platform when toileting.

34. The method of claim 32 wherein the seat support platform is moveably mounted and step (a) comprises lowering the seat support platform and step (c) comprises raising the seat support platform.

35. The method of claim 32 further comprising using a mirror surface provided beneath the seat support platform and positioned to permit a person adjacent the chair to view the toileting opening when the chair is in the position at the end of step (a) and the bedpan has been removed.

36. The method of claim 32 wherein the chair further comprises a rigid member positionable over the bedpan opening and beneath the upper surface of the removable seat and the method further comprises removing the rigid member with the removable seat prior to the person toileting.

37. The method of claim 32 wherein the chair further comprises a rigid member that extends over the bedpan opening and the method further comprises moving the rigid member to expose the bedpan opening prior to a person using the bedpan for toileting.

38. The method of claim 32 wherein the rigid member comprises part of the removable seat whereby step (d) comprises simultaneously removing the removable seat and the rigid member.

39. The method of claim 32 wherein the rigid member comprises a moveable closure member affixed to the chair and the method further moving the closure member to an open position to expose the bedpan opening prior to a person using the bedpan for toileting.
